(19) United States
(12) Patent Application Publication
(10) Pub. No.: US 2024/0386047 A1
(43) Pub. Date: Nov. 21, 2024

(54) COLD-START FORECASTING VIA BACKCASTING AND COMPOSITE EMBEDDING

(71) Applicant: Oracle International Corporation, Redwood Shores, CA (US)

(72) Inventors: Ankit Aggarwal, Mumbai (IN); Chirag Ahuja, Delhi (IN); Vikas Pandey, Bangalore (IN); Sharmily Sidhartha, Bangalore (IN); Hariharan Balasubramanian, Redmond, WA (US); Jie Xing, Redmond, WA (US)

(73) Assignee: Oracle International Corporation, Redwood Shores, CA (US)

(21) Appl. No.: 18/198,975

(22) Filed: May 18, 2023

(51) Int. Cl. G06F 16/38; G06F 16/31

(52) U.S. Cl. CPC G06F 16/38; G06F 16/316

(57) ABSTRACT

Techniques are described herein for cold-start forecasting datasets using backcasting and composite embedding. An example method can include a system receiving a set of time series and metadata text comprising a first subset of metadata text and a second subset of metadata text. The system can generate a plurality of embeddings, each embedding comprising a numerical representation of a metadata text of the set of metadata text. The system can generate a plurality of vectors, each vector comprising a time series of the set of time series each time series associated with a metadata text of the first subset of metadata text. The system can generate a plurality of composite embeddings based at least in part on combining each embedding with a respective vector of the plurality of vectors. The system can determine a forecasted value associated with the second subset of metadata text based on the composite embeddings.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

### BRIEF SUMMARY

Embodiments herein are directed toward cold-start forecasting datasets using backcasting and composite embedding. One embodiment includes a method for cold-start forecasting datasets using backcasting and composite embedding. The method includes a computing system receiving a set of time series and an associated set of metadata text comprising a first subset of metadata text and a second subset of metadata text, the first subset of metadata text associated with the set of time series.

The method further includes the computing system generating a plurality of embedding, each embedding of the plurality of embeddings comprising a numerical representation of a metadata text of the set of metadata text.

The method further includes the computing system generating a plurality of vectors, each vector of the plurality of vectors comprising a time series of the set of time series each time series of the set of time series associated with a metadata text of the first subset of metadata text.

The method further includes the computing system generating a plurality of composite embeddings based at least in part on combining each vector of the plurality of embeddings with a respective vector of the plurality of vectors.

The method further includes the computing system determining a forecasted value associated with the second subset of metadata text based at least in a part on the plurality of composite embeddings.

Embodiments can further include a computing system, including a processor and a computer-readable medium including instructions that, when executed by the processor, can cause the processor to perform operations including receiving a set of time series and an associated set of metadata text comprising a first subset of metadata text and a second subset of metadata text, the first subset of metadata text associated with the set of time series.

The instructions that, when executed by the processor, can further cause the processor to perform operations including generating a plurality of embeddings, each embedding of the plurality of embeddings comprising a numerical representation of a metadata text of the set of metadata text.

The instructions that, when executed by the processor, can further cause the processor to perform operations including generating a plurality of vectors, each vector of the plurality of vectors comprising a time series of the set of time series each time series of the set of time series associated with a metadata text of the first subset of metadata text.

The instructions that, when executed by the processor, can further cause the processor to perform operations including generating a plurality of composite embeddings based at least in part on combining each embedding of the plurality of vectors with a respective vector of the plurality of vectors.

The instructions that, when executed by the processor, can further cause the processor to perform operations including determining a forecasted value associated with the second subset of metadata text based at least in a part on the plurality of composite embeddings.

Embodiments can further include a non-transitory computer-readable medium including stored thereon instructions that, when executed by the processor, can cause the processor to perform operations including receiving a set of time series and an associated set of metadata text comprising a first subset of metadata text and a second subset of metadata text, the first subset of metadata text associated with the set of time series.

The instructions that, when executed by the processor, can further cause the processor to perform operations including generating a plurality of embeddings, each embedding of the plurality of embeddings comprising a numerical representation of a metadata text of the set of metadata text.

The instructions that, when executed by the processor, can further cause the processor to perform operations including generating a plurality of vectors, each vector of the plurality of vectors comprising a time series of the set of time series each time series of the set of time series associated with a metadata text of the first subset of metadata text.

The instructions that, when executed by the processor, can further cause the processor to perform operations including generating a plurality of composite embeddings based at least in part on combining each embedding of the plurality of embeddings with a respective vector of the plurality of vectors.

The instructions that, when executed by the processor, can further cause the processor to perform operations including determining a forecasted value associated with the second subset of metadata text based at least in a part on the plurality of composite embeddings.

### BRIEF DESCRIPTION OF THE DRAWINGS

FIG. 1 is an illustration of a cold-start forecasting system using backcasting and composite embeddings, according to one or more embodiments.

FIG. 2 is an illustration of a time series metadata table, according to one or more embodiments.

FIG. 3 is a plot of a backcasted time series, according to one or more embodiments.

FIG. 4A is a plot of incomplete time series data values, according to one or more embodiments.

FIG. 4B is an inverted plot of incomplete time series data values, according to one or more embodiments.

FIG. 5 is an illustration of a plot with backcasted values, according to one or more embodiments.

FIG. 6 is a process flow for forecasting values using a composite embedding, according to one or more embodiments.

FIG. 7 is a process flow for determining whether to generate backcasted values using a composite embedding, according to one or more embodiments.

FIG. 8 is a process flow for generating backcasted values, according to one or more embodiments.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Cloud service providers (CSPs) can offer machine learning-based forecasting services to their customers. A customer can provide data in the form of a time series and request forecasting values for one or more future time points. The CSP forecasting service can train a machine learning model using a portion of the data as training data, and validate the machine learning model using a balance of the data. The CSP forecasting service can then use the trained machine learning model to generate the forecasted values.

In some instances, a customer sends a request for forecasted values, in which there is no direct time series data values to use to forecast the values. For example, a customer may need forecasted values for expected traffic for a new website that is to be launched. The customer may be a mixed media company that has a sports division, an entertainment division, a media division, and is starting a financial division. The customer may further be launching an interactive website for their financial division. The customer can provide data for the customer traffic for websites for their sports division, entertainment division, and media division. However, as the financial division is starting and there is no financial division website, there is text data describing the website, but no historical time series data for website traffic of the financial division website. To compound the issue, it is possible that the data for one or more of the websites for the sports division, entertainment division, and media division only include recent data (e.g., historical website traffic data for the past three years for a website that is five years old). Therefore, the CSP forecasting service has to determine how to forecast future values without direct time series data values and further to potentially account for incomplete data provided by a customer. Furthermore, the accuracy of the forecasted values should be comparable to a scenario in which the forecasting service has a complete data set, including direct time series data values.

Embodiments described herein address the above-referenced issues by providing cold-start forecasting techniques that can use backcasting and composite embeddings. Cold start forecasting refers to forecasting values for future time points for a time series that has little to no time series data values. The accuracy of a machine-learning model configured for cold start forecasting can be enhanced using composite embedding. The composite embeddings are generated by combining embedding generated from any metadata text provided by the customer and the time series data values (time series vectors). A vector can be a mathematical representation of a data point in a multi-dimensional space. Each dimension of the vector can correspond to a feature or attribute of a time series. An embedding can be a vector representation of a word or phrase that has been learned through a machine learning model (e.g., a language model). An embedding can be used in natural language processing tasks such as sentiment analysis, text classification, and machine translation. An embedding can be learned by training a language model on a large dataset of text and optimizing the model to predict a numerical representation of the context of each word based on its surrounding words. The outputted embedding can capture semantic relationships between words, such as synonyms, antonyms, and related concepts.

The forecasting service can use the composite embedding to determine which time series provided by a customer is closest to the time series for which the service is to generate forecasting values. Using the example, above, the forecasting service can create respective composite embeddings from the sports division, entertainment division, and media division website traffic data. The forecasting service can further use a nearest neighbor algorithm (e.g., K-nearest neighbor (KNN)) to determine which of the composite embedding is the most similar to the financial division website metadata. The forecasting service can then forecast future values using a time series data values from the composite embedding that is most similar to an embedding generated from financial division website metadata. For example, based on the nearest neighbor search, the forecasting service can conclude that a composite embedding associated with the entertainment division is most similar to an embedding generated from the financial division website metadata. The forecasting service can further use time series data values from the entertainment division website traffic data to forecast values for expected traffic for the launch of the financial division website.

As indicated above, in some instances, the customer provided data is incomplete as to the requested forecasted values. For example, the customer's entertainment division website can be five years old. However, the customer only has the past three years of website traffic data. Therefore, the customer cannot provide time series data values for website traffic at the launch of the entertainment division website. In situations such as this, the forecasting service can use backcasting to determine values for the earlier time points (e.g., the first two years) using more recent time series data. For example, the forecasting service can use a backcasting technique on the past three years of the entertainment division website traffic data to determine values for the first two years of entertainment division website traffic data. The forecasting service can then forecast the expected values of the website traffic for the launch of the financial division website using the determined values for the first two years of entertainment division website traffic data.

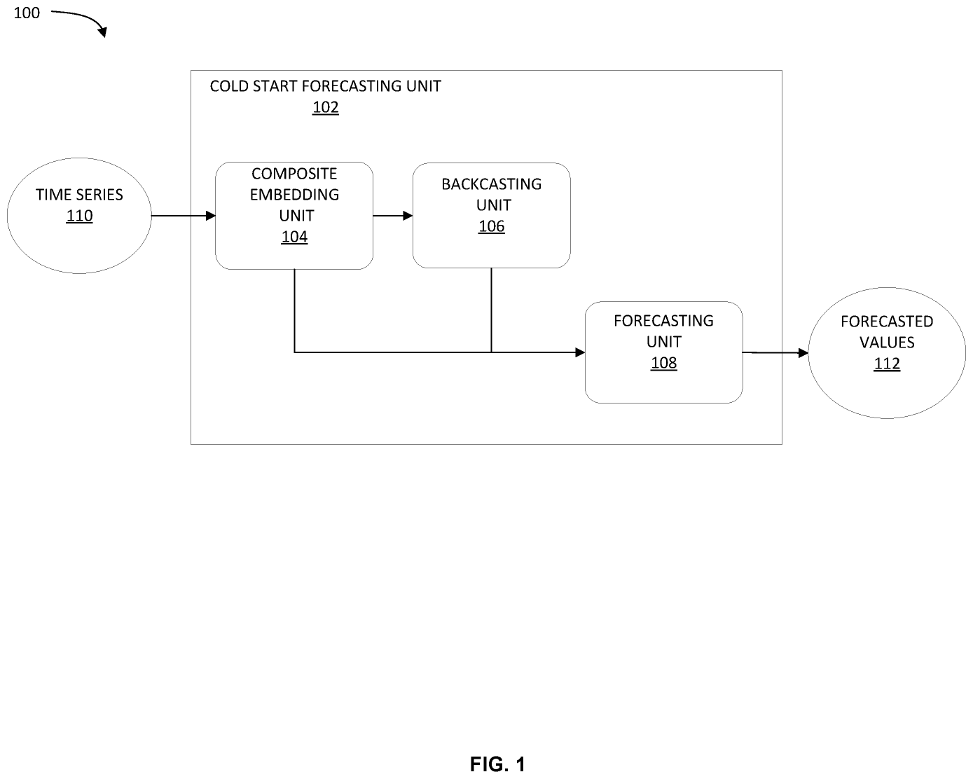

FIG. 1 is an illustration 100 of a cold-start forecasting system using backcasting and composite embeddings, according to one or more embodiments. The cold start forecasting unit 102 can include a composite embedding unit 104, a backcasting unit 106, and a forecasting unit 108, and is operable to receive a time series 110 and output forecasted values 112. The cold-start forecasting system can be implemented by a forecasting service of a cloud service provider. For example, the forecasting service can implement the cold-start forecasting system using the cloud services infrastructure described herein.

The composite embedding unit 104 can receive a set of time series. Each time series can include time series, additional data, and metadata. The time series can include time series values (e.g., daily website traffic numbers for the sports division, entertainment division, and media division). The additional data can be related data with a temporal component (e.g., respective marketing campaign statistics for the sports division, entertainment division, and media division). The metadata can include static data associated with the time series data values (e.g., website hosting service, general website characteristics, website content categories).

The composite embedding unit 104 can receive a set of time series from a customer of a forecasting service. The set of time series can include two or more time series that include time series values, additional data, and metadata. The composite embedding unit 104 can further receive a time series that includes the additional data, and/or the metadata, but no time series values. A customer can transmit a request for forecasted values for the time series that does not include the time series values.

The composite embedding unit 104 can generate composite embeddings from the two or more time series that include time series data values, additional data, and metadata. The composite embedding unit 104 can employ a language model to convert the metadata text to an embedding. For example, the language model can be configured for a word2vec technique that is trained to represent words and/or phrases with embeddings, where the embeddings are numerical representation of the semantic and syntactical characteristics of the words and/or phrases. The composite embedding unit can input the metadata text into a language model (e.g., a machine learning model trained to word2vec technique) to generate an embedding. The metadata can be organized in a data structure, such as a table where each row is associated with a source (e.g., sports division, entertainment division, and media division) and each column is associated with a metadata category. For example, a table can include a column header, a row header column, and five rows of metadata, where the first row can be associated with the sports division, the second row can be associated with the entertainment division, the third row can be associated with the media division, and the fourth row can be associated with the financial division. Each column cell can include data in a text format related to an associated row. For example, the first column can include data describing a website content. For example, the first column first row cell can include the metadata text “sports related news,” the first column second row cell can include the metadata text “movies and television news,” the first column third row cell can be include the metadata text “#1 local and national news”, and the first column fourth row can include the metadata text “24/7 financial news.”

The language model can take data in text format from each cell and convert the metadata text into an embedding that represents the text's semantic and syntactical characteristics. The language model can append a column header, a row header and a metadata cell text for each cell to create numerical representations for each table cell. For example, the column header can be “content description”, the row header can be “sports division,” and the metadata cell text can be “sports related news.” The language model can append “content description”+“sports division”+“sports related news” and generate an embedding. Each respective column value can be used to generate a corresponding embedding. For example, using the word2vec algorithm, the composite embeddings unit 104 can generate an embedding of 768 numbers that numerically represents the text of a column cell. The word2vec algorithm can further combine embeddings generated from each cell of a row. Therefore, a row embedding can include 768*N, where N is the number of columns in a row.

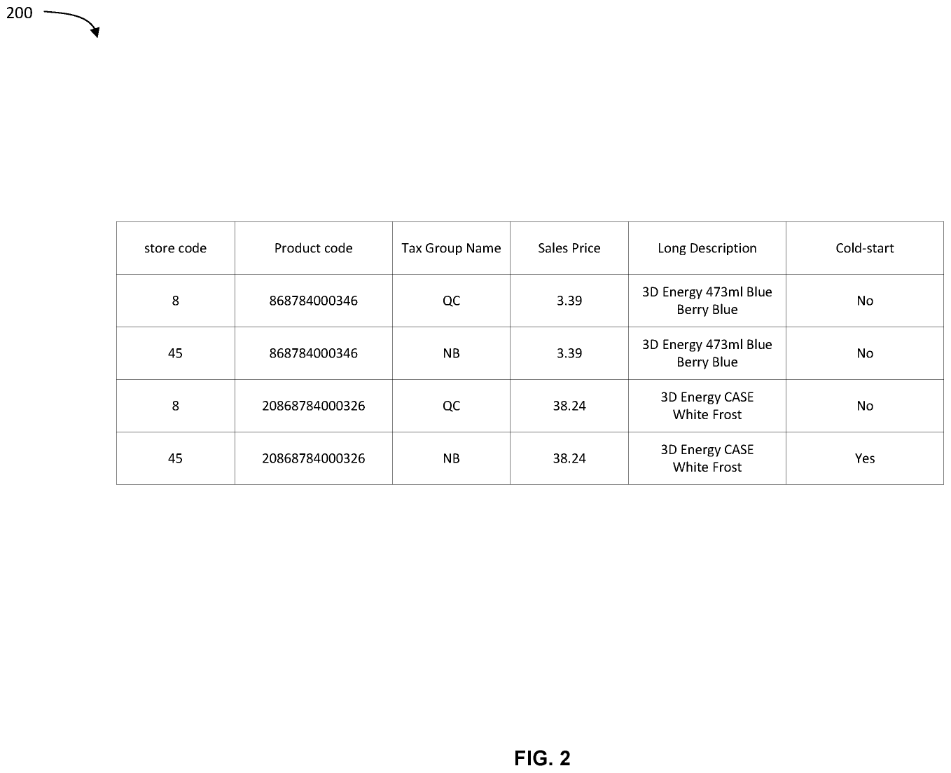

The composite embeddings unit 104 can further generate a vector based on associated time series values (e.g., time series values) with metadata text. Continuing to use the example from above, the composite embedding unit 104 can use a cat2vec algorithm to generate a vector based on the website traffic numbers for each division. Generation of the vectors from the time series values is described with more particularity with respect to FIG. 2.

FIG. 2 is an illustration of a time series metadata table 200, according to one or more embodiments. The table 200 includes five column headers: location code, product code, tax group name, sales price, long description, and cold-start. The table relates to product launches at two different stores, store 8 and store 45. The products include a single bottle of berry blue energy drink (3D Energy 473 ml Blue Berry Blue) and a case of white frost energy drink (3D Energy CASE White Frost).

The single bottle berry blue energy drink and the case of white frost energy drink have each been sold in store 8 and store 45. The case of white frost energy drink has been sold in store 8, but not in store 45. The owner of store 8 and store 45 has asked a forecasting service to forecast the sales of the case of white frost energy drink at store 45. The owner of store 8 and store 45 has provided time series sales data for single bottle berry blue energy drink sales at store 8 and store 45. The owner has further provided time series sales data for the case of white frost energy drink at store 8. The owner has not provided time series sales data for the case of white frost energy drink at store 45, as the case of white frost energy drink has not been sold at store 45 as of yet.

The composite embeddings unit 104 can iteratively create a vectors using the historical sales data by running a loop c times over the metadata text of each cell, where c is the number of metadata columns. For each loop, the composite embeddings unit 104 can map the metadata value to an aggregated time series vector. For each column, the composite embeddings unit 104 can determine which row metadata text are the same. For example, in FIG. 2, in the first column, there are two rows associated with store 8 and two rows associated with 45. The composite embeddings unit 104 can take all of the time series values associated with a same metadata text and combine the associated time series. For example, the composite embeddings unit 104 can take each time series associated with store 8 and combine the values (e.g., combine time series sales data for single bottle berry blue energy drink data and time series sales data for the case of white frost energy drink at store 8 to reach total sales of both drinks at store 8). The composite embeddings unit 104 can perform the same operation for store 45 (e.g., combine sales data for single bottle berry blue energy drink data and sales data for the case of white frost energy drink at store 45 to reach total sales of both drinks at store 45).

To complete the loop, the composite embeddings unit 104 can perform this operation over each column of the time series metadata table 200. For example, the composite embeddings unit 104 can then move to the second column. In the second column, there are metadata values for product code 868784000346 and product code 20868784000326. The composite embeddings unit 104 can then combine the time series sales data for the product with code 868784000346 (e.g., combine time series sales data from store 8 and store 45 for the product with code 868784000346). The composite embedding unit 104 can then combine the time series sales data for the product with code 868784000346 (e.g., combine the time series sales data from store 8 and store 45 for the product with code 20868784000326). The composite embeddings unit 104 unit can keep repeating this procedure for each column of the time series metadata table 200.

The composite embeddings unit 104 can concatenate all of the generated vectors to generate an aggregated vector for each source. For example, store 8 is associated with the metadata text 868784000346, 20868784000326, QC, 3.39, 38.24, 3D Energy 473 ml Blue Berry Blue, and 3D Energy CASE White Frost. The composite embeddings unit 104 can generate an aggregated vector that includes time series values for each time series that includes data described by one or more of these metadata text instances. The composite embeddings unit 104 can use a dimensionality reduction algorithm to reduce the number of dimensions of the aggregated vector. For example, the composite embeddings unit 104 can use a principle component analysis (PCA) to reduce the dimensionality of the vector. Using the PCA, the composite embeddings unit 104 can calculate a covariance matrix of the vector's n data points. The composite embeddings unit 104 can then determine eigen vectors and corresponding eigen values for the matrix. The composite embeddings unit 104 can then sort the eigen vectors based on their eigen values in descending order. The composite embeddings unit 104 can then select the first k eigen vectors, which will be the new k dimensions of the vector. The composite embeddings unit 104 can then transform the original n dimensions of the vector into k dimensions.

The composite embeddings unit 104 can then respectively combine each reduced dimensionality vector to each of embeddings generated using the metadata text per each source. Referring to FIG. 2, the composite embeddings unit 104 can have generated three embeddings using the metadata text. For example, the composite embeddings unit 104 can create a first embedding for store 8 by generating numerical representations of the first row of metadata text (e.g., 8, 868784000346, QC, 3.39, and 3D Energy 473 ml Blue Berry Blue). The composite embeddings unit 104 can create a second embedding by generating numerical representations of the second row of metadata text for store 45. The composite embeddings unit 104 can create a third embedding by generating numerical representations of the third row of metadata text for store 8. The composite embeddings unit 104 can create a fourth embedding by generating numerical representations of the fourth row of metadata text for store 45. The composite embeddings unit 104 can then combine each dimensionality reduced vector to each of these embeddings to generate four composite embeddings based on the source. For example, the first composite embedding is the concatenation of the first embedding associated with store 8 and the dimensionality reduced vector associated with store 8.

The embedding generated from metadata text that is not associated with time series data can remain as is. The composite embeddings unit 104 can keep the fourth embedding as is to be used for a cold-start forecasting to generate future forecasted values.

The composite embeddings unit 104 then performs a nearest neighbor search to determine which of the composite embeddings associated with time series data values is closest to the composite embedding that is not associated with time series values (e.g., the fourth embedding). The nearest neighbor search can be a k nearest neighbor search. For example, the composite embeddings unit 104 can select a value for k. The composite embeddings unit 104 can then calculate the Euclidean distance of the data points of the composite embedding that is not associated with time series data values and the data points of each other composite embedding. The composite embeddings unit 104 can then determine which of the other k composite embeddings is closest to the composite embedding that is not associated with time series data values.

Referring to FIG. 2, the composite embeddings unit 104 can calculate the respective Euclidean distance of the fourth embedding to the first composite embedding, the second composite embedding, and the third composite embedding. The composite embeddings unit 104 can then determine which of the first composite embedding, the second composite embedding, and the third composite embedding is closest to the fourth embedding (e.g., k=1). The composite embedding that is closest to the fourth embedding is the one whose time series data values will be used to generate forecasted values. For example, if the second composite embedding, associated with store 45 and the single bottle of berry blue energy drink is closest to the fourth embedding, associated with store 45 and the case of white frost energy drink, then the time series sales data for single bottle of berry blue energy drink at store 45 can be used to forecast the launch of sales for the case of white frost energy drink at store 45.

As indicated above, in some instances, the customer has provided complete time series data values. For example, the store 45 has sold the single bottle of berry blue energy drink for five years, and the customer has provided five years of sales data. In these instances, the composite embedding unit 104 can transmit the time series data values (e.g., historical sales data for the single bottle of berry blue energy drink at store 45) to the forecasting unit 108. The forecasting unit 108 can include a machine learning model trained to use a forecasting technique (e.g., Prophet, autoregressive integrated moving average (ARIMA), exponential smoothing). The forecasting unit 108 can then the use the time series data values to generate forecasted values 112 for the launch of sales for the case of white frost energy drink at store 45 using the forecasting technique.

In other instances, however, the customer has not provided complete data, the composite embeddings unit 104 can transmit the time series data values to be used for forecasting to the backcasting unit 106. For example, the store 45 has sold the single bottle of berry blue energy drink for five years, and the customer has provided three most recent years of sales data. As the requested forecasted values pertain to the launch of sales of the case of white frost energy drink at store 45, sales data collected after sales for the single bottle of berry blue energy drink are well established are not as valuable as sales data collected at the launch of sales of the single bottle of berry blue energy.

The backcasting unit 106 can use the time series data values to generate backcasted values. Unlike traditional forecasting methods, which typically involve using past trends to make predictions about the future, backcasting starts with recent data to generate values for the past. In other words, the backcasting unit 106 could use the most recent three years of sales data for the single bottle of berry blue energy drink at store 45 to generate backcasted values for the first two years of sales of berry blue energy drink at store 45.

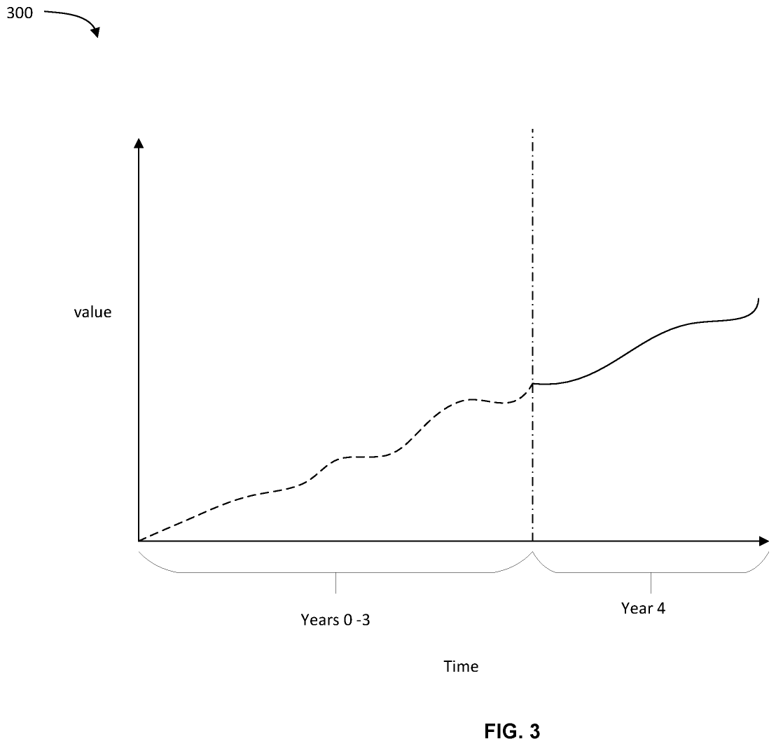

FIGS. 3, 4A, 4B, and 5 are provided to illustrate the operations of the backcasting unit 106. FIG. 3 is a plot 300 of a backcasted time series, according to one or more embodiments. The plot 300 includes value on a y-axis and time on an x-axis. As illustrated, a customer has provided time series data values for year 4 of a pattern. The year 4 data is illustrated as a solid line. The customer did not provide data for years 0 through 3 of the pattern. The backcasting unit 108 can use one or more backcasting techniques analyze the time series data values for year to identify any parameters (e.g., upward sloping trend, downward sloping trend, seasonality). The backcasting unit 108 can further use the identified parameters to generate backcasted values. The backcasted values for years 0 to 3 have been illustrated as a dashed line.

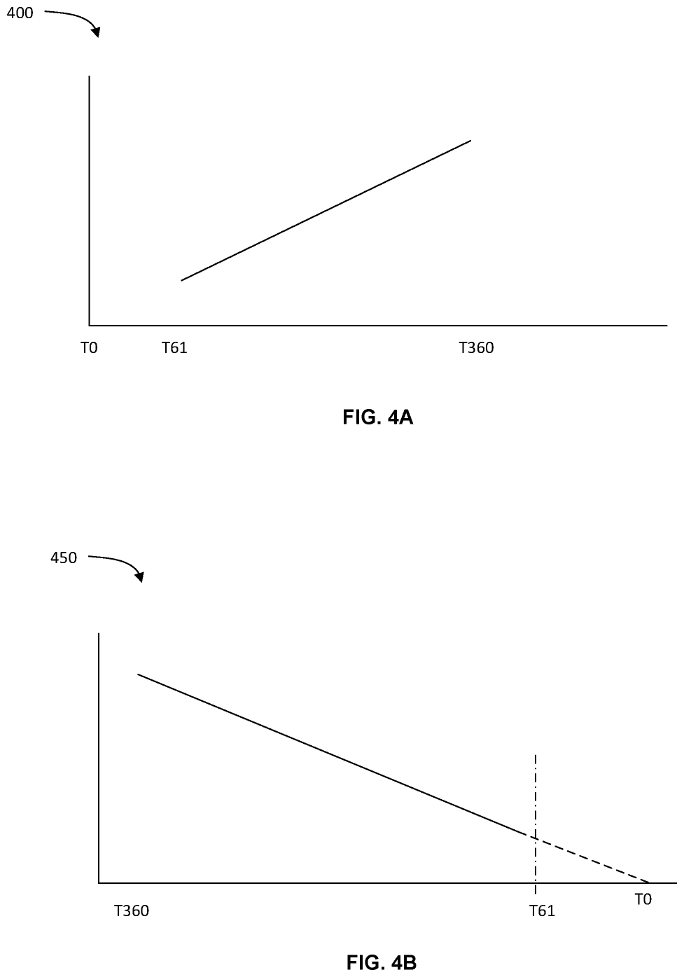

FIG. 4A is a plot 400 of incomplete time series data values, according to one or more embodiments. A customer has provided time series data values received from a first store for time 61 to time 360. For, example the plot 400 can be of time series data values that has been determined to be a nearest neighbor (e.g., time series data values associated with the second composite embedding from above) for a time series for which forecasted values are to be generated. As illustrated, the customer does not have the time series data values from time 0 to time 60, and therefore the composite embedding unit 104 did not receive the data. As a result, the composite embedding unit 104 was unable to transmit time series data values from time 0 to time 60 to the backcasting unit 106.

FIG. 4B is an inverted plot 450 of incomplete time series data values, according to one or more embodiments. The time series data values have been chronologically inverted, such that the plot flows from time 360 to time 61, rather than chronologically from time 61 to time 360. The backcasting unit 106 can use one or more forecasting techniques to forecast values for time 61 (T61) to time 0 (T0). As illustrated, the forecasted values are in a dashed line. The backcasting unit 108 can employ a machine learning model training for a forecasting technique. The forecasting technique can be the same forecasting technique to be used to determine the requested forecasted values.

In some instances, the backcasting unit 106 can further use a model (e.g., a Bass Diffusion model, Gompertz model, logistic growth model, exponential growth model, or Diffusions of Innovation Theory). The selection of the model can be based on a forecasting objective. For example, a Bass diffusion model can assume that the adoption of a new product is driven by two types of consumers: innovators and imitators. The innovators are the first to adopt a new product, while imitators can adopt the product later, influenced by the innovators. The Bass diffusion model can be based on two parameters: the coefficient of innovation, which represents the rate at which innovators adopt the new product, and the coefficient of imitation, which represents the rate at which imitators adopt the product. These parameters are estimated based on historical data on the adoption of similar products in the market. The backcasting unit 106 can use these parameters, for a Bass diffusion model to predict the total number of product adopters over time, as well as the timing of adoption.

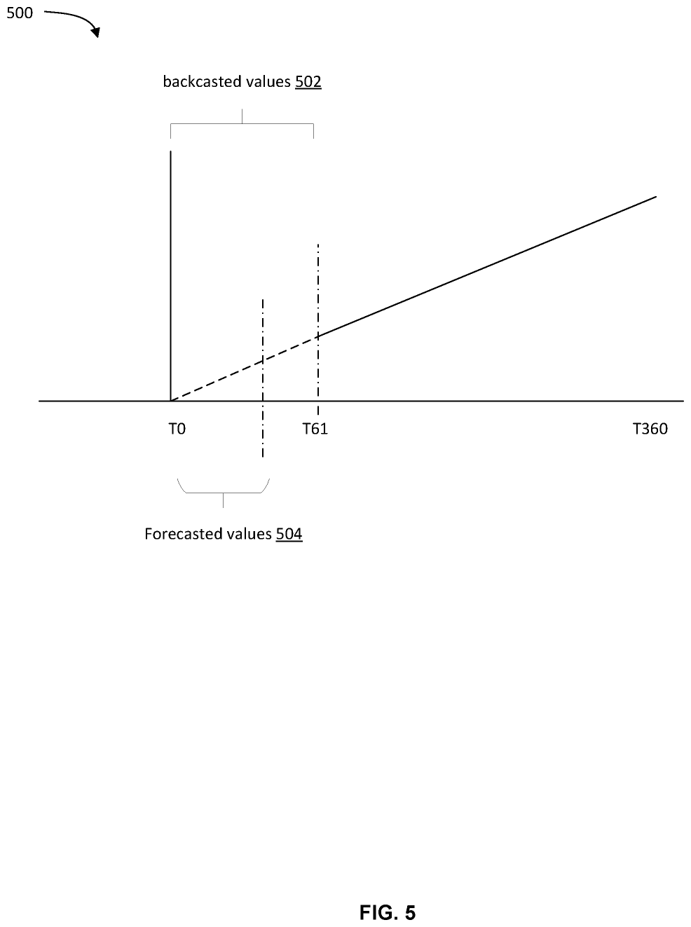

FIG. 5 is an illustration of a plot 500 with backcasted values, according to one or more embodiments. The plot generated as described in FIG. 4B has been inverted back to original position in FIG. 4A. As seen the values are in chronological order from time 0 to time 1 to time 360. The backcasted values 502 range from time 0 to time 60. The time series data values range from time 61 to time 360. The backcasted values 502 are illustrated as dashed lines and the time series data values is illustrated as a solid line. The backcasting unit 106 can transmit the data from the plot 500 to the forecasting unit. The forecasting unit can determine which values from the backcasted values are the forecasted values 504. As illustrated the forecasted values 504 can be a subset of the backcasted values 502.

As seen, the cold start forecasting unit 102 can forecast values using composite embedding where a customer has provided metadata, but without corresponding time series data values. The cold start forecasting using 102 can further forecast values using backcasting in situations in which incomplete historical data from one time series is being used to forecast values for another time series.

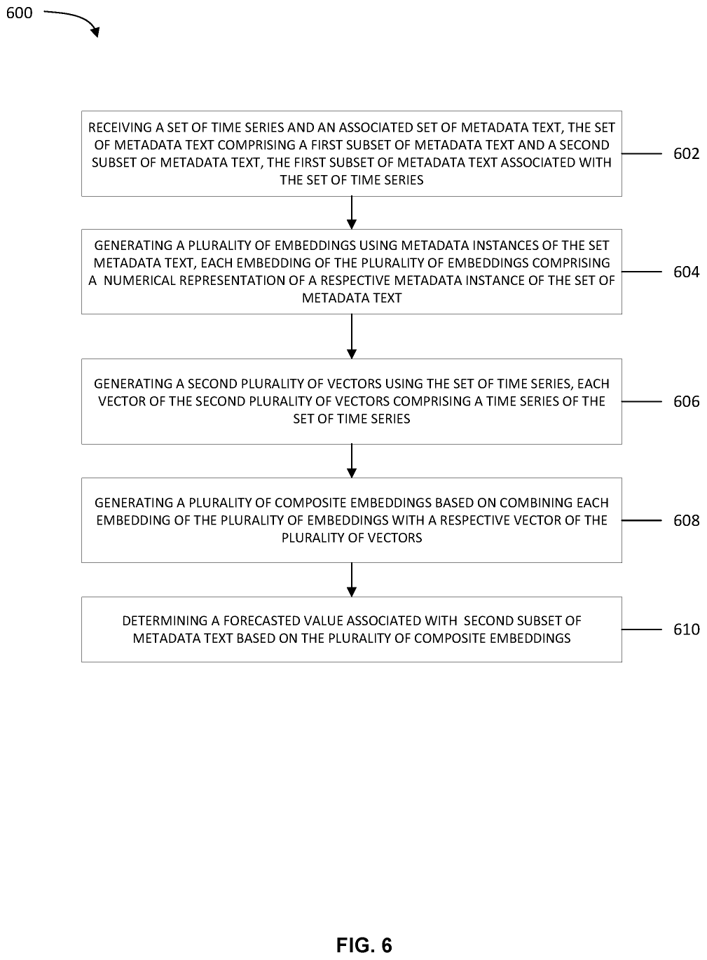

FIG. 6 is a process flow 600 for forecasting values using a composite embedding, according to one or more embodiments. While the operations of processes 600, 700, and 800 are described as being performed by generic computers, it should be understood that any suitable device (e.g., a user device, a server device) may be used to perform one or more operations of these processes. Processes 600, 700, and 800 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 602, the process can include a computing system receiving a set of time series and an associated set of metadata text comprising a first subset of metadata text and a second subset of metadata text, the first subset of metadata text associated with the set of time series. The computing system can include a cold start forecasting unit as described above. Each time series of the set of time series can include time series, additional data, and metadata. Each time series can include time series values. The additional data can be related data with a temporal component. The metadata can include static data associated with the time series data values. The first subset of metadata values can include metadata text associated with a time series. The second subset of metadata values can include metadata text that is not associated with a time series.

At 604, the process can include the computing system generating a plurality of embeddings, each embedding of the plurality of embeddings comprising a numerical representation of a metadata text of the set of metadata text. The metadata text can be organized in a data structure, such as a table where each row is associated with a source and each column is associated with a metadata category. The computing system can employ a language model that can take data in text format from each cell and convert the metadata text into an embedding that represents the text's semantic and syntactical characteristics. The language model can append a column header, a row header and a metadata cell text for each cell to create numerical representations for each table cell.

At 606, the process can include the computing system generating a plurality of vectors, each vector of the plurality of vectors comprising a time series of the set of time series each time series of the set of time series associated with a metadata text of the first subset of metadata text. The computing system can iteratively create a vectors using the time series values data by running a loop c times over the metadata text of each cell, where c is the number of metadata columns. For each loop, the computing system can map the metadata value to a time series vector. For each column, the computing system can determine which row metadata text are the same. The computing system can take all of the time series values associated with a same metadata text and combine the associated time series. To complete the loop, the computing system can perform this operation over each column of the time series metadata table. The computing system can further use dimensionality reduction algorithm to reduce the dimensionality of the vectors.

At 608, the process can include the computing system generating a plurality of composite embeddings based at least in part on combining each embedding of the plurality of embeddings with a respective vector of the plurality of vectors. The computing system can respectively combine each reduced dimensionality vector to each of embeddings generated using the metadata text per each source.

At 610, the process can include the computing system determining a forecasted value associated with the second subset of metadata text based on the plurality of composite embeddings. The computing system can use a forecasting technique to determine the forecasted values.

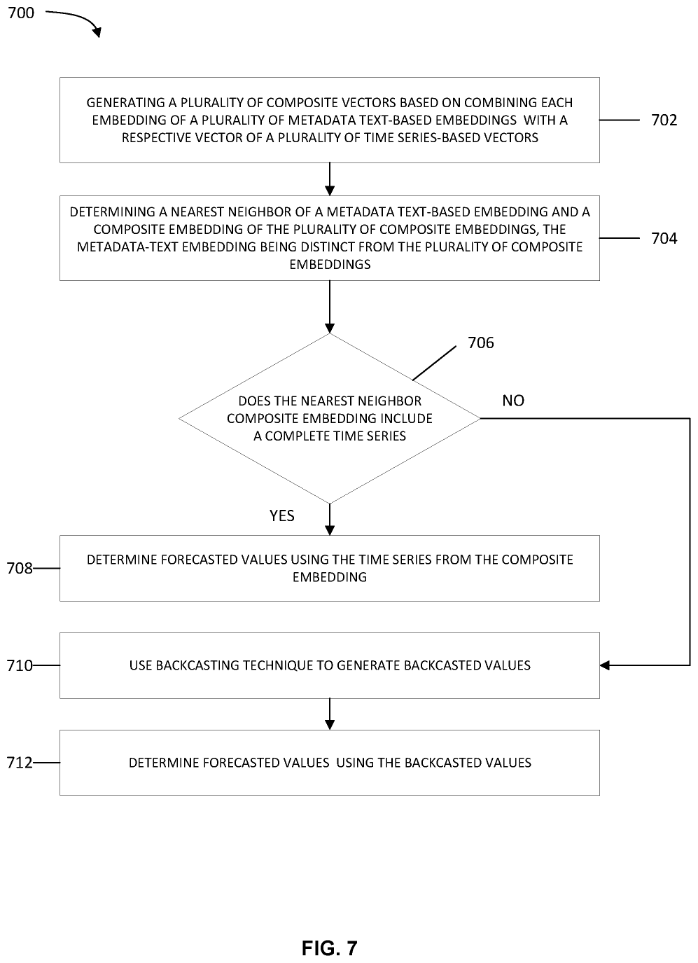

FIG. 7 is a process flow 700 for determining whether to generate backcasted values using a composite embedding, according to one or more embodiments. At 702, the process can a computing system generating a plurality of composite embeddings based at least in part on combining each vector of a plurality of metadata text-based vectors with a respective vector of a plurality of time-series based vectors. The computing system can be a forecasting system as described above. The computing system can receive a set of time series and an associated set of metadata text comprising a first subset of metadata text and a second subset of metadata text, the first subset of metadata text associated with the set of time series.

The metadata text can be organized in a data structure, such as a table where each row is associated with a source and each column is associated with a metadata category. The computing system can employ a language model that can take data in text format from each cell and convert the metadata text into an embedding that represents the text's semantic and syntactical characteristics. The language model can append a column header, a row header and a metadata cell text for each cell to create numerical representations for each table cell.

The computing system can iteratively create a vectors using the time series values data by running a loop c times over the metadata text of each cell, where c is the number of metadata columns. For each loop, the computing system can map the metadata value to a time series vector. For each column, the computing system can determine which row metadata text are the same. The computing system can take all of the time series values associated with a same metadata text and combine the associated time series. To complete the loop, the computing system can perform this operation over each column of the time series metadata table. The computing system can further use dimensionality reduction algorithm to reduce the dimensionality of the vectors. The computing system can respectively combine each reduced dimensionality vector to each of embeddings generated using the metadata text per each source.

At 704, the process flow can include the computing system determining a nearest neighbor of a metadata text-based embedding and a composite embedding of the plurality of compositing embeddings. The meta-data text embedding being distinct from the plurality of composite embeddings. The nearest neighbor search can be a k nearest neighbor search. The computing system can then calculate the Euclidean distance of the data points of the composite embedding that is not associated with time series data values and the data points of each other composite embedding. The computing system can then determine which of the other k composite embeddings is closest to the composite embedding that is not associated with time series data values.

At 706, the process can include computing system can determine whether nearest neighbor composite embedding includes a complete time series. In some instances, a customer has provided complete time series data values. In other instances, the customer has provided an incomplete complete time series data values. For example, the computing system can apply a model-based approach to determine whether the time series is complete time series or an incomplete time series.

If the nearest neighbor includes a complete time series, the process can include the computing system determining forecasted values using the composite embedding at 708. The computing system can use a forecasting technique to determine the forecasted values using the composite embedding.

If the nearest neighbor does not include a complete time series, the process can include the computing system using a forecasting technique to generate backcasted values at 710. The computing system can chronologically invert the incomplete time series. The computing system can then forecast values for future time points of the chronologically inverted time series. The computing system can then invert the chronologically inverted time series, such that the values are in a correct chronological order.

At 712, the process can include the computing system determining forecasted values using the backcasted values. The computing system can use a forecasting technique to determine the forecasted values using the backcasted values.

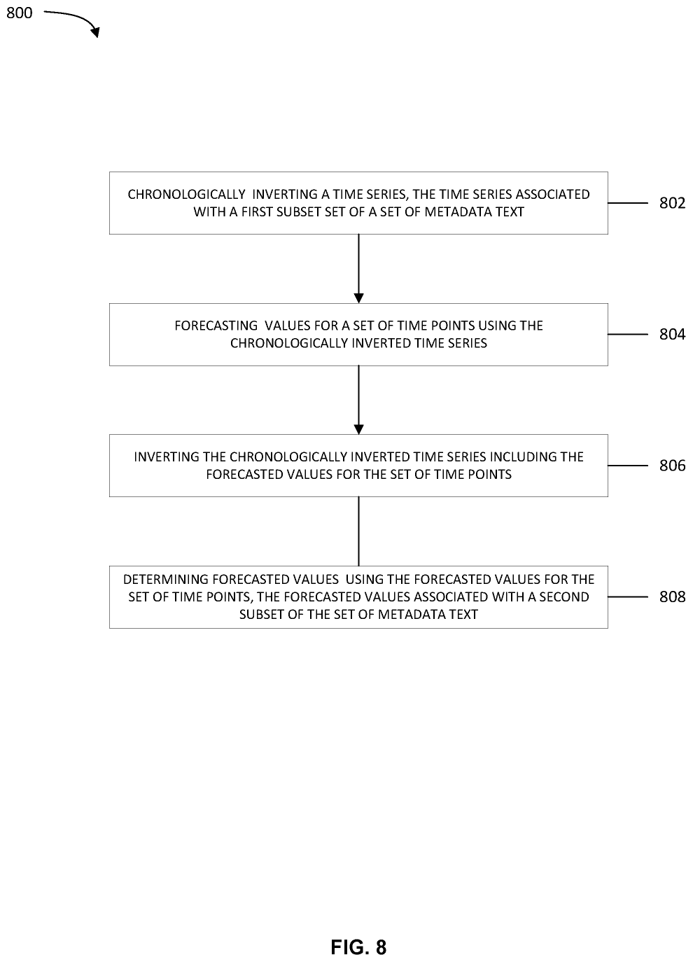

FIG. 8 is a process flow 800 for generating backcasted values, according to one or more embodiments. At 802, the process can include chronologically inverting a time series, the time series associated with a first subset of a set of metadata text. The time series can be an incomplete time series that does not include values from the origin of the event described by the time series. For example, if the time series describes website traffic numbers, the incomplete time series fails to include time series values for a time period following the launch of the website.

At 804, the process can include the computing system forecasting values for a set of time points using the chronologically inverted time series. The computing system can use a forecasting technique (e.g., Prophet, autoregressive integrated moving average (ARIMA), exponential smoothing) to determine the forecasted values using the chronologically inverted time series.

At 806, the process can include the computing system inverting the chronologically inverted time series including the forecasted values for the set of time points. Therefore, the time series values can be in a correct chronological order.

At 808, the process can include the computing system determining forecasted values using the forecasted values for the set of time points, the forecasted values associated with a second subset of the set of metadata text.

It should be appreciated that the process flow 800 can be applied to an upward trending time series (e.g., the time series of FIG. 4A). As illustrated in FIG. 4B, chronologically inverting the time series of FIG. 4A can result in a downward trending time series. The computing system can further forecast values from T61 to T0 using the downward trending time series. The forecasted values can converge to a value of 0 at T0. As seen in FIG. 5, when the time series data points, including the forecasted values 504, are placed in chronological order from T0 to T360, the time series values begin a 0 at T0, and continue to trend upward until T360.

Consider an alternative example, in which the time series is a downward trending time series. If the computing system chronologically inverted the downward trending time series, the result would be an upward trending time series. Furthermore, if the computing system were to forecast values for the upward trending time series, the values would not converge to 0. Rather the forecasted values would continue an upward trend. Then, for example, if the computing system were to place the data points in chronological order, the value a T0 would not be 0. Therefore, for a downward trending time series, the computing system can use a parametric model to generate the backcasted values.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

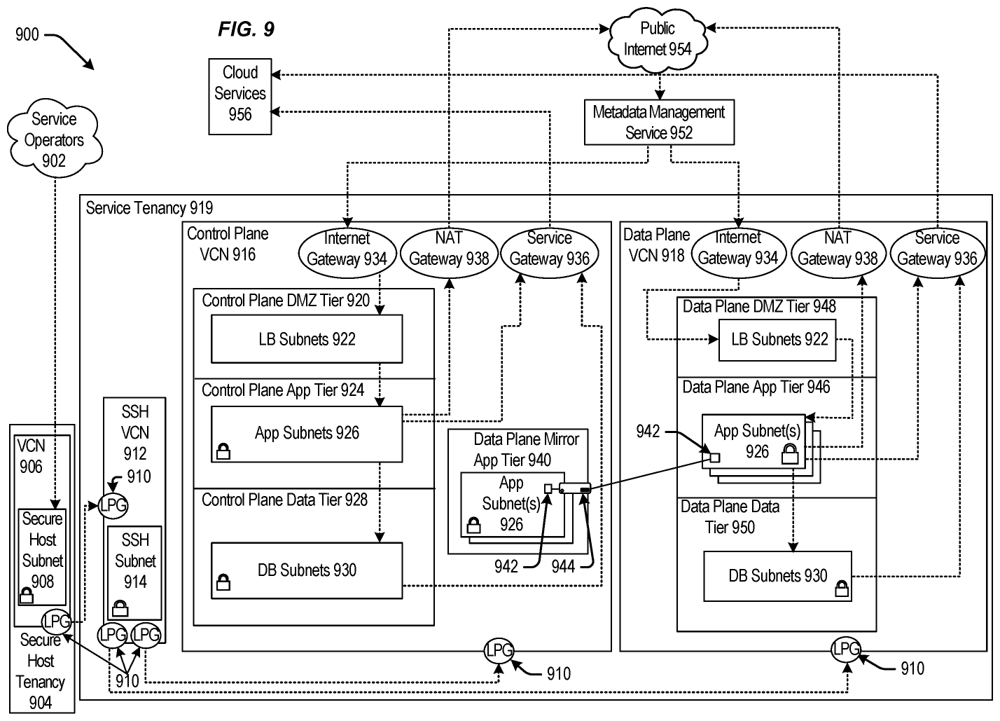

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

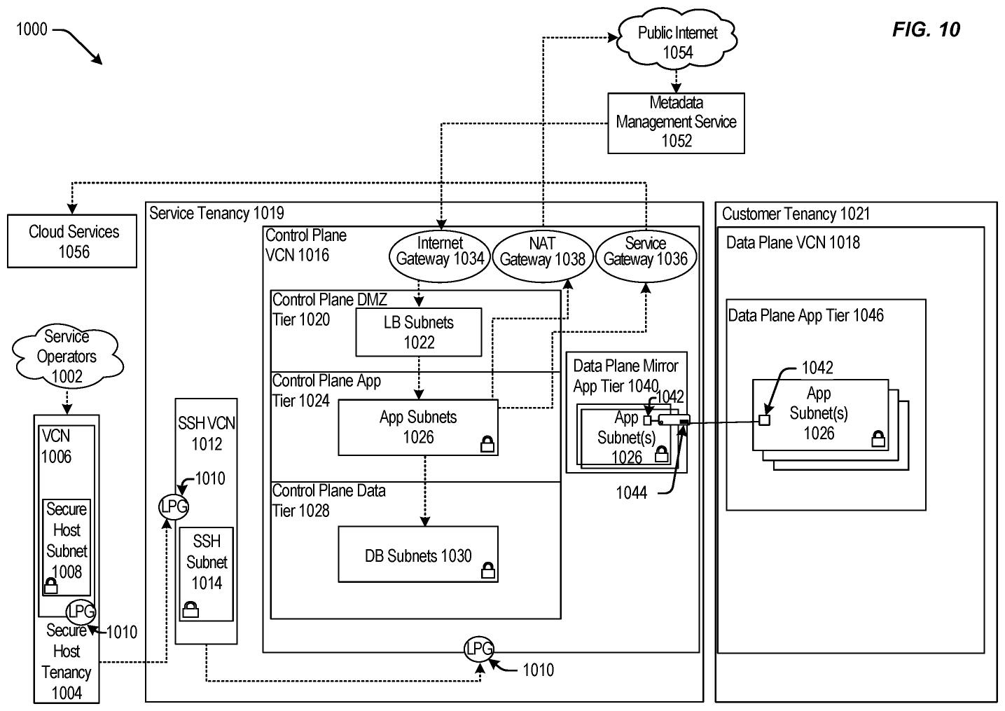

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

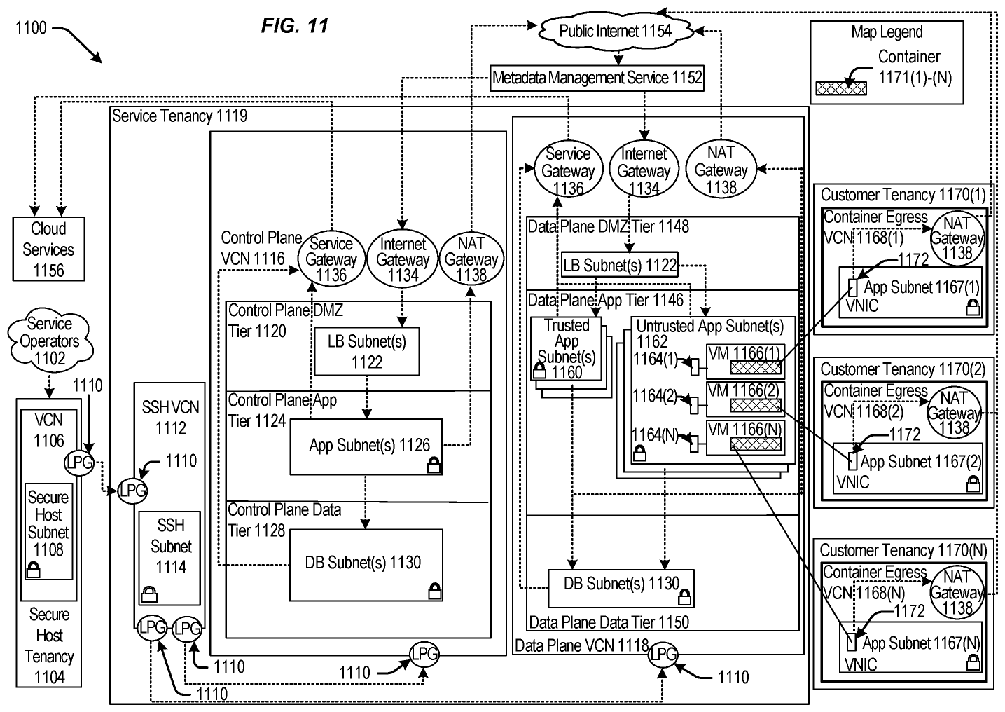

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

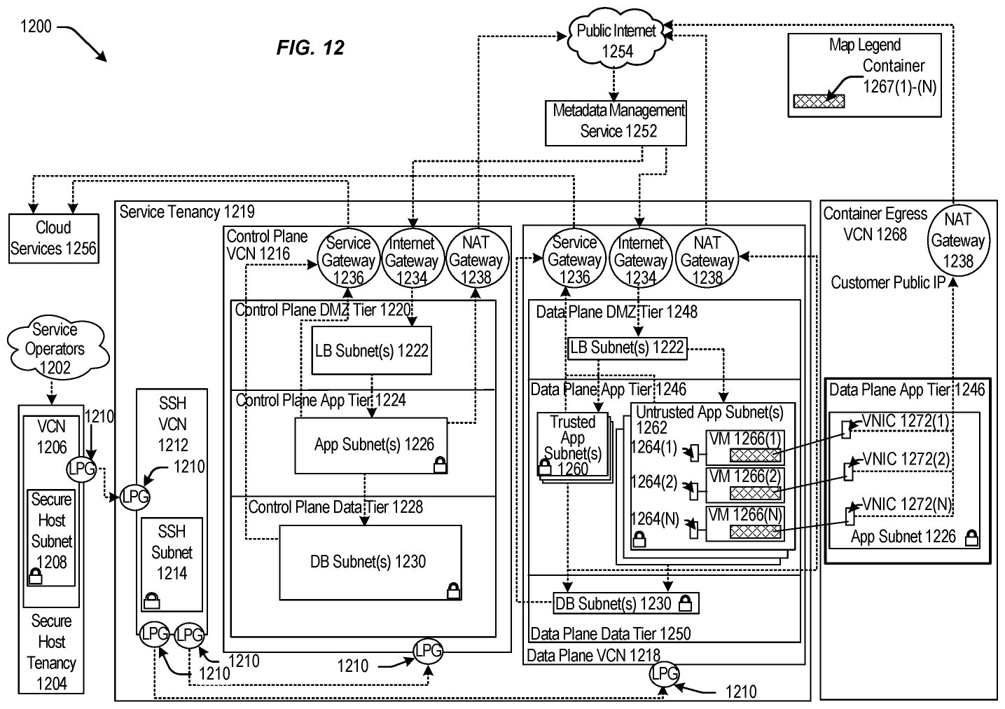

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

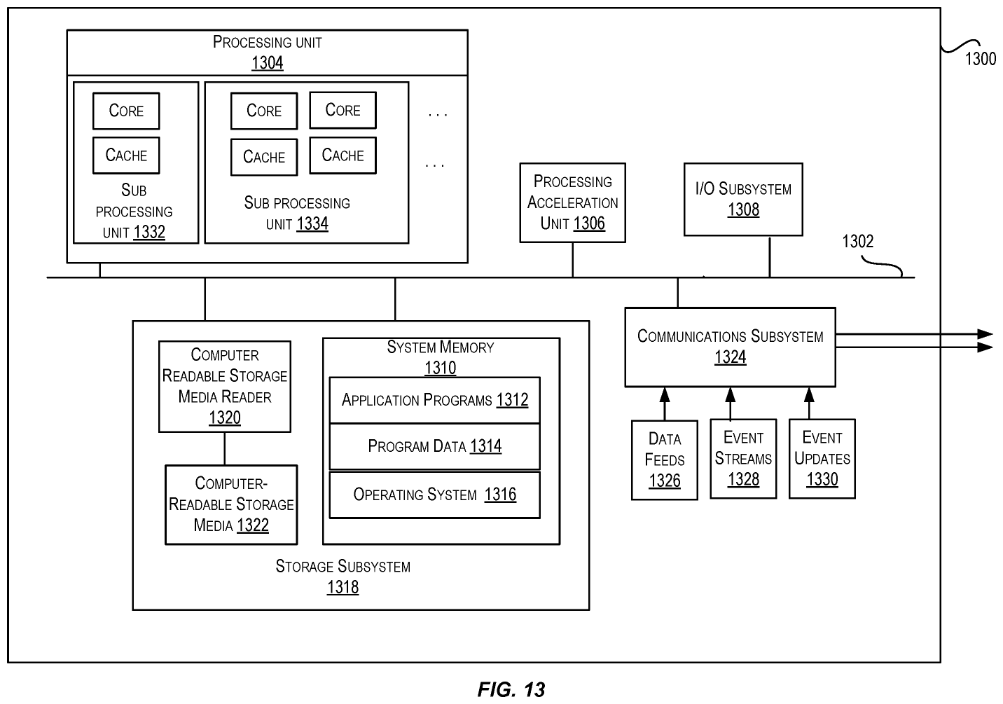

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that comprises software elements, shown as being currently located within a system memory 1310. System memory 1310 may store program instructions that are loadable and executable on processing unit 1304, as well as data generated during the execution of these programs.

Depending on the configuration and type of computer system 1300, system memory 1310 may be volatile (such as random access memory (RAM)) and/or non-volatile (such as read-only memory (ROM), flash memory, etc.) The RAM typically contains data and/or program services that are immediately accessible to and/or presently being operated and executed by processing unit 1304. In some implementations, system memory 1310 may include multiple different types of memory, such as static random access memory (SRAM) or dynamic random access memory (DRAM). In some implementations, a basic input/output system (BIOS), containing the basic routines that help to transfer information between elements within computer system 1300, such as during start-up, may typically be stored in the ROM. By way of example, and not limitation, system memory 1310 also illustrates application programs 1312, which may include client applications, Web browsers, mid-tier applications, relational database management systems (RDBMS), etc., program data 1314, and an operating system 1316. By way of example, operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1318 may also provide a tangible computer-readable storage medium for storing the basic programming and data constructs that provide the functionality of some embodiments. Software (programs, code services, instructions) that when executed by a processor provide the functionality described above may be stored in storage subsystem 1318. These software services or instructions may be executed by processing unit 1304. Storage subsystem 1318 may also provide a repository for storing data used in accordance with the present disclosure.

Storage subsystem 1300 may also include a computer-readable storage media reader 1320 that can further be connected to computer-readable storage media 1322. Together and, optionally, in combination with system memory 1310, computer-readable storage media 1322 may comprehensively represent remote, local, fixed, and/or removable storage devices plus storage media for temporarily and/or more permanently containing, storing, transmitting, and retrieving computer-readable information.

Computer-readable storage media 1322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1300.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a set of time series and an associated set of metadata text comprising a first subset of metadata text and a second subset of metadata text, the first subset of metadata text associated with the set of time series;
generating, by the computing system, a plurality of embeddings, each embedding of the plurality of embeddings comprising a numerical representation of a metadata text of the set of metadata text;
generating, by the computing system, a plurality of vectors, each vector of the plurality of vectors comprising a time series of the set of time series each time series associated with a metadata text of the first subset of metadata text;
generating, by the computing system, a plurality of composite embeddings based at least in part on combining each embedding of the plurality of embeddings with a respective vector of the plurality of vectors; and
determining, by the computing system, a forecasted value associated with the second subset of metadata text based at least in a part on the plurality of composite embeddings.

2. The method of claim 1, wherein the set of metadata text comprises a table of metadata text, and wherein generating the plurality of embeddings comprises inputting each table row of metadata text into a language model to generate a respective numerical representation of the row of metadata text.

3. The method of claim 1, wherein the set of metadata text comprises a table of metadata text, and wherein generating the plurality of vectors comprises:
determining each column cell of a first table column comprising a same metadata text of the set of metadata text;
determining each time series of the set of time series comprising data described by the same metadata text; and
generating a vector of the plurality of vectors by combining the determined each time series of the set of time series comprising data described by the same metadata text.

4. The method of claim 1, wherein generating the plurality of composite embeddings comprises combining a first embedding of the plurality of embeddings with a vector of the plurality of vectors, the embedding generated using a same metadata text of the set of metadata text as associated with the vector.

5. The method of claim 1, wherein determining the forecasted value comprises:
comparing an embedding of the plurality of embeddings generated using the second subset of metadata text with the plurality of composite embeddings to determine a nearest neighbor of the embedding; and
determining the forecasted value using a composite embedding of the plurality of composite embeddings that is the nearest neighbor of the embedding of the plurality of embedding.

6. The method of claim 5, wherein the composite embedding of the plurality of composite embeddings comprises incomplete an incomplete time series, and wherein the method further comprises using a forecasting technique on the incomplete time series to generate backcasted values.

7. The method of claim 6, wherein determining the forecasted value associated with the second subset of metadata text based at least in a part on the plurality of composite embeddings comprises using the backcasted values to determine the forecasted value.

8. A computing system, comprising:
a processor; and
a computer-readable medium including instructions that, when executed by the processor, cause the processor to perform operations comprising:
receiving a set of time series and an associated set of metadata text comprising a first subset of metadata text and a second subset of metadata text, the first subset of metadata text associated with the set of time series;
generating a plurality of embeddings, each embedding of the plurality of embeddings comprising a numerical representation of a metadata text of the set of metadata text;
generating a plurality of vectors, each vector of the plurality of vectors comprising a time series of the set of time series each time series associated with a metadata text of the first subset of metadata text;
generating a plurality of composite embeddings based at least in part on combining each embedding of the plurality of embeddings with a respective vector of the plurality of vectors; and
determining a forecasted value associated with the second subset of metadata text based at least in a part on the plurality of composite embeddings.

9. The computing system of claim 8, wherein the set of metadata text comprises a table of metadata text, and wherein generating the plurality of embeddings comprises inputting each table row of metadata text into a language model to generate a respective numerical representation of the row of metadata text.

10. The computing system of claim 8, wherein the set of metadata text comprises a table of metadata text, and wherein generating the plurality of vectors comprises:
determining each column cell of a first table column comprising a same metadata text of the set of metadata text;
determining each time series of the set of time series comprising data described by the same metadata text; and
generating a vector of the plurality of vectors by combining the determined each time series of the set of time series comprising data described by the same metadata text.

11. The computing system of claim 8, wherein generating the plurality of composite embeddings comprises combining a first embedding of the plurality of embeddings with a vector of the plurality of vectors, the embedding generated using a same metadata text of the set of metadata text as associated with the vector.

12. The computing system of claim 8, wherein determining the forecasted value comprises:
comparing an embedding of the plurality of embeddings generated using the second subset of metadata text with the plurality of composite embeddings to determine a nearest neighbor of the embedding; and
determining the forecasted value using a composite embedding of the plurality of composite embeddings that is the nearest neighbor of the embedding of the plurality of embedding.

13. The computing system of claim 12, wherein the composite embedding of the plurality of composite embeddings comprises incomplete an incomplete time series, and wherein the instructions that, when executed by the processor, further cause the processor to perform operations comprising using a forecasting technique on the incomplete time series to generate backcasted values.

14. The computing system of claim 13, wherein determining the forecasted value associated with the second subset of metadata text based at least in a part on the plurality of composite embeddings comprises using the backcasted values to determine the forecasted value.

15. A non-transitory computer-readable medium having stored thereon a sequence of instructions that, when executed by a processor, causes the processor to perform operations comprising:
receiving a set of time series and an associated set of metadata text comprising a first subset of metadata text and a second subset of metadata text, the first subset of metadata text associated with the set of time series;
generating a plurality of embeddings, each embedding of the plurality of embeddings comprising a numerical representation of a metadata text of the set of metadata text;
generating a plurality of vectors, each vector of the plurality of vectors comprising a time series of the set of time series each time series associated with a metadata text of the first subset of metadata text;
generating a plurality of composite embeddings based at least in part on combining each embedding of the plurality of embeddings with a respective vector of the plurality of vectors; and
determining a forecasted value associated with the second subset of metadata text based at least in a part on the plurality of composite embeddings.

16. The non-transitory computer-readable medium of claim 15, wherein the set of metadata text comprises a table of metadata text, and wherein generating the plurality of embeddings comprises inputting each table row of metadata text into a language model to generate a respective numerical representation of the row of metadata text.

17. The non-transitory computer-readable medium of claim 15, wherein the set of metadata text comprises a table of metadata text, and wherein generating the plurality of vectors comprises:
determining each column cell of a first table column comprising a same metadata text of the set of metadata text;
determining each time series of the set of time series comprising data described by the same metadata text; and
generating a vector of the plurality of vectors by combining the determined each time series of the set of time series comprising data described by the same metadata text.

18. The non-transitory computer-readable medium of claim 15, wherein generating the plurality of composite embeddings comprises combining a first embedding of the plurality of embeddings with a vector of the plurality of vectors, the embedding generated using a same metadata text of the set of metadata text as associated with the vector.

19. The non-transitory computer-readable medium of claim 15, wherein determining the forecasted value comprises:
comparing an embedding of the plurality of embeddings generated using the second subset of metadata text with the plurality of composite embeddings to determine a nearest neighbor of the embedding; and
determining the forecasted value using a composite embedding of the plurality of composite embeddings that is the nearest neighbor of the embedding of the plurality of embedding.

20. The non-transitory computer-readable medium of claim 19, wherein the composite embedding of the plurality of composite embeddings comprises incomplete an incomplete time series, and wherein the instructions that, when executed by the processor, further cause the processor to perform operations comprising using a forecasting technique on the incomplete time series to generate backcasted values.
